(19) United States
(12) Patent Application Publication
(10) Pub. No.: US 2025/0000244 A1
(43) Pub. Date: Jan. 2, 2025

(54) Carrying Strap Device

(71) Applicant: Elizabeth Chesney, Kearns, UT (US)

(72) Inventor: Elizabeth Chesney, Kearns, UT (US)

(21) Appl. No.: 18/492,148

(22) Filed: Oct. 23, 2023

Related U.S. Application Data
(60) Provisional application No. 63/523,667, filed on Jun. 28, 2023.

(51) Int. Cl. A45F 3/14; B60N 2/28

(52) U.S. Cl. CPC A45F 3/14; B60N 2/2842; A45F 2003/142

(57) ABSTRACT

A carrying strap device is disclosed that provides an improved carrying strap system for infant car seats. The carrying strap device comprises a body component of four straps that are configured in a rectangular shape and connect with the top right, bottom right, top left, and bottom left of the infant car seat through a securing means such as finger screw down clamps and anchors. The body component would be made of a polyester material which contains a strap adjuster for length adjustment. The body component also comprises a pad component which connects all four straps of the body component together with hook and loop fasteners. Thus, each carrying strap device functions as a suitable way of carrying an infant in a car seat while also maintaining comfort and ease, greatly increasing the safety of the infant.

### CROSS-REFERENCE TO RELATED APPLICATION

The present application claims priority to, and the benefit of, U.S. Provisional Application No. 63/523,667, which was filed on Jun. 28, 2023, and is incorporated herein by reference in its entirety.

### FIELD OF THE INVENTION

The present invention relates generally to the field of carrying strap devices. More specifically, the present invention relates to a carrying strap for attaching to an infant car seat to increase comfort. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in carrying strap devices. Generally, people use infant car seats to carry their infants around in. This may be convenient because then the infant does not need to be transferred between different seats; however, these car seats are very large and wieldy and can be difficult and heavy to hold and carry. Further, carrying an infant car seat can be difficult and uncomfortable due to how the manufactured handle is installed on the seat. A parent or guardian's hand is placed in an awkward position and puts the child at risk of being dropped. Carrying infant car seats by their standard handles can lead to pain and fatigue. Accordingly, people may be looking for a more comfortable and secure way to carry their infants/children around.

Further, the use of infant carrying straps to hold infants is well-known in the prior art. However, it would be desirable to include a set of straps placed in a specific way for maximum comfort and decreased use of strength. For example, it would be desirable to provide a way for a person to hold the car seat close to the body and in a comfortable position, to reduce the arm strength necessary and thus reduce fatigue. These carrying straps are placed on each edge of the car seat for an equal distribution of weight, thus reducing the weight of the carrier. Whereas, most car seats only have one handle and are top heavy which makes it difficult for movement. Accordingly, the handle places the child and the user's hand in an awkward position which puts the infant at risk of being dropped or harmed in any way.

Accordingly, there is a demand for an improved carrying strap device that can cause comfort and case for the person carrying the infant car seat. More particularly, there is a demand for a four-strap carrying strap device that distributes car seat weight and includes a comfortable handle to increase comfort for the user and safety for the infant.

Therefore, there exists a long-felt need in the art for a carrying strap device that provides users with an improved carrying strap system for infant car seats. There is also a long-felt need in the art for a carrying strap device that features a comfortable handle that meets in the middle of four exterior straps connected to the car seat, offering a secure grip to carry the seat with case. Further, there is a long-felt need in the art for a carrying strap device that includes finger screw clasps with an anchor that fits under the molded edges of the car seat to firmly hold the four straps in place. Moreover, there is a long-felt need in the art for a device that ensures the car seat can be carried with the palm side toward the body to reduce pain and fatigue. Further, there is a long-felt need in the art for a carrying strap device that prevents an infant from being dropped due to awkward hand positioning and top-heavy weight distribution. Finally, there is a long-felt need in the art for a carrying strap device that can also be adjusted for comfort, handling it over the shoulder.

The subject matter disclosed and claimed herein, in one embodiment thereof, comprises a carrying strap device. The device is a secondary carrying strap system that attaches to a pre-existing car seat via multiple secure attachment points. The carrying strap device comprises a body component that is comprised of four separate straps that connect underneath the outer lip of the infant car seat. The body component connects in the middle of the car seat where a pad is attached for more comfortable support and a way for all four straps to be combined. The body component also comprises a finger screw down clasp with an anchor shaped to fit under the molded edge of the car seat, to secure each strap to the car seat. Thus, each carrying strap device functions as a more comfortable way to carry an infant in a car seat. The device can also be modified so that it can be placed over the shoulder of the user, as well.

In this manner, the carrying strap device of the present invention accomplishes all of the foregoing objectives and provides users with a device that provides users with an improved carrying strap system for infant car seats. The device is a set of four straps connected in the middle by a pad. The device can be manufactured of any suitable resilient material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a carrying strap device. The device is a secondary carrying-strap system that attaches to a pre-existing infant car seat via multiple secure attachment points. The carrying strap device comprises a body component that is configured of four rectangular straps. The body component would be connected in the middle of the car seat by a pad configured from comfortable materials. Thus, each carrying strap device functions as a suitable way of carrying an infant in a car seat, while also maintaining comfort and ease, which greatly increases the safety of the infant.

In one embodiment, the carrying strap device comprises a body component of four rectangular bands. These four bands are comprised of polyester or any other suitable material and each contains a strap adjuster in order to control the length of all four straps. In one embodiment, only two rectangular straps are utilized. One strap is secured at the right ends of the car seat and the second strap is secured at the left ends of the car seat. The middle of the two straps are then secured together over the car seat.

In one embodiment, the carrying strap device comprises a body component that is connected to the car seat through a securing means. The body component will attach to the car seat under the molded edge of the car seat through a means of finger screw down clasps and an anchor. Further, each of the four straps of the body component will be placed on a different side of the car seat; there being an upper right, lower right, upper left, and lower left side to the car seat.

In one embodiment, the body component comprised of the four straps is connected to the four straps through a pad component made of comfortable material. Further, this pad component would be where the user places their hand when carrying the car seat and should be rectangular. The pad component should also contain hook and loop fasteners that cause the pad component to completely encircle all four straps when the straps are held together in the center of the car seat. The pad component is not a part of the body component and thus whenever the straps of the body component are held together in one hand, the pad component can then be wrapped around all four straps and secured to itself through hook and loop fasteners; thus, holding the four straps together.

In one embodiment, the pad component is held by the user's hand, which allows the user to hold their palm towards their body which decreases exhaustion and fatigue caused by the strain of a regular car seat. Thus, the infant will be protected from the danger of being dropped or harmed.

In one embodiment, the pad component is placed on the user's shoulder. The straps move so that they are elongated to comfortably fit around the user's shoulder and thus, the car seat is hanging off of the user's shoulder during use.

In use, the carrying strap device is assembled by first screwing the polyester straps into the fasteners on the edges of the pre-existing infant car seat. Each strap is screwed into a separate side of the car seat; the top right, bottom right, top left, and bottom left. The body component is adjusted to the ideal length using the strap adjusters. The straps of the body component are held together in the user's hand. The pad component is then wrapped around all of the straps in the body component and secured via hook and loop fasteners. Thus, a user holds the pad component to carry the infant within the car seat and since the weight has been equally distributed, the pad component is made of comfortable material, and the pad component is in a more comfortable handling location, the user is more at case carrying their infant around.

In one embodiment, the carrying strap device can be utilized with any suitable infant car seat or carrier in which it can attach along the edges of the structure.

In yet another embodiment, the carrying strap device comprises a plurality of indicia.

In yet another embodiment, a method of carrying an infant car seat with secondary straps is disclosed. The method includes the steps of providing a carrying strap device comprising a body component and a pad component. The method also involves securing the body component around the molded edges of a pre-existing car seat via the finger screw down clasp with an anchor. Further, the method comprises adjusting the body component straps with strap adjusters to the preferred length. The method also comprises connecting the pad component to the body component by wrapping the pad component around all the straps of the body component and securing the pad component together using hook and loop fasteners. Finally, the method comprises holding the pad component so that the palm is facing the body to reduce fatigue.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the carrying strap device of the present invention showing the device applied to an infant car seat in accordance with the disclosed architecture;

FIG. 2 illustrates a side perspective view of one embodiment of the carrying strap device of the present invention showing how the straps are secured in accordance with the disclosed architecture;

FIG. 3 illustrates a perspective view of one embodiment of the carrying strap device of the present invention showing how the pad component wraps around the body component in accordance with the disclosed architecture;

FIG. 4 illustrates a front perspective view of one embodiment of the carrying strap device of the present invention showing how the pad component is situated in the middle of the car seat in accordance with the disclosed architecture;

FIG. 5 illustrates a back perspective view of one embodiment of the carrying strap device of the present invention showing the strap adjusters on the two topmost straps in accordance with the disclosed architecture; and

FIG. 6 illustrates a flowchart showing the method of carrying an infant car seat with secondary straps in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a carrying strap device that provides users with an improved carrying strap system for infant car seats. There is also a long-felt need in the art for a carrying strap device that features a comfortable handle that meets in the middle of four exterior straps connected to the car seat, offering a secure grip to carry the car seat with ease. Further, there is a long-felt need in the art for a carrying strap device that includes finger screw clasps with an anchor that fits under the molded edges of the car seat to firmly hold the four straps in place. Moreover, there is a long-felt need in the art for a device that ensures the car seat can be carried with the palm side toward the body to reduce pain and fatigue. Further, there is a long-felt need in the art for a carrying strap device that prevents an infant from being dropped due to awkward hand positioning and top-heavy weight distribution. Finally, there is a long-felt need in the art for a carrying strap device that can be placed over the shoulder for more comfort as well.

The present invention, in one exemplary embodiment, is a novel carrying strap device. The device is a secondary carrying strap system that attaches to a pre-existing car seat via multiple secure attachment points. The carrying strap device comprises a body component that is configured of four straps each configured in a long rectangular shape. The body component would be a polyester, seatbelt-like material that would be difficult to break or snap to ensure the safety of both the user and the infant. The body component also comprises strap adjusters in order to allow the user to control the length of each of the straps. Thus, each carrying strap device functions as a suitable way of carrying an infant car seat while using the least amount of strength and exertion. The present invention also includes a novel method of carrying an infant car seat with secondary straps. The method includes the steps of providing a carrying strap device comprising a body component and a pad component. The method also comprises securing the body component around the molded edges of a pre-existing car seat via a finger screw down clasp with an anchor. The method also comprises adjusting the body component straps with strap adjusters to the preferred length. The method also comprises connecting the pad component to the body component by wrapping the pad component around all the straps of the body component and securing the pad component together using hook and loop fasteners. Finally, the method comprises holding the pad component so that the palm is facing the body to reduce fatigue.

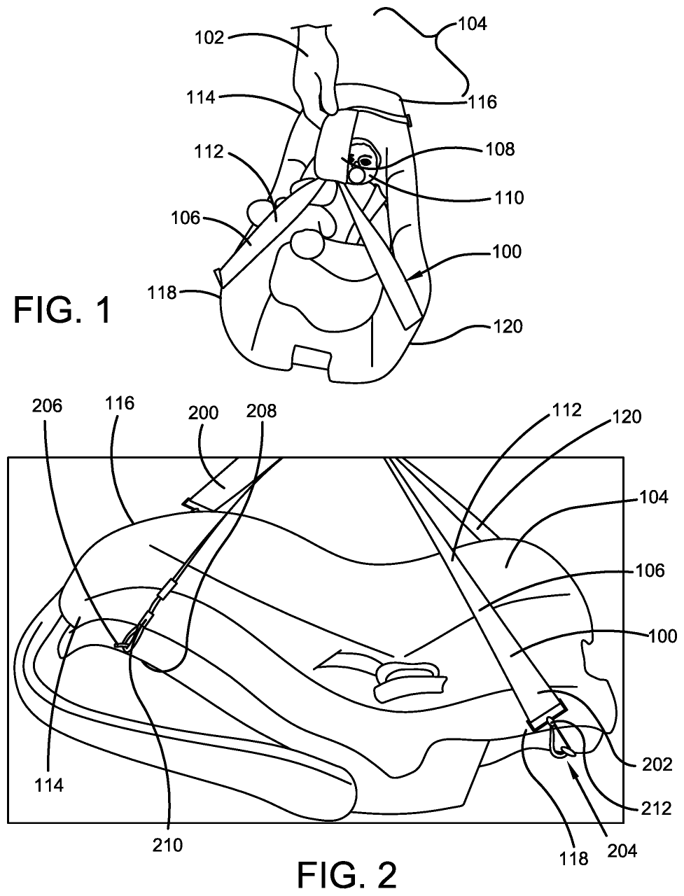

Referring initially to the drawings, FIG. 1 illustrates a front perspective view of one embodiment of the carrying strap device 100 of the present invention. In the present embodiment, the carrying strap device 100 is an improved carrying strap device 100 that provides a user 102 with a secondary carry strap system that attaches to a pre-existing car seat 104 via multiple secure attachment points. Further, the device 100 is four straps that are screwed into the car seat 104 under the molded edge 208 and connected at the top. Specifically, the carrying strap device 100 comprises a body component 106 of four straps and a pad component 108 that connects all of them using hook and loop fasteners 300. Thus, each carrying strap device 100 functions as a suitable way of carrying an infant 110 in a car seat 104 with comfort and increased case.

Generally, the carrying strap device 100 comprises a body component 106 and a pad component 108. The body component 106 is comprised of four straps made from a polyester material 112 that are placed on the top right 114, top left 116, bottom right 118, and bottom left 120 of the infant car seat 104. Further, the straps are connected to one another by the pad component 108 which allows the user 102 to comfortably handle and maneuver the car seat 104.

In another embodiment, only two rectangular straps are utilized. One strap is secured at the right ends 114 and 118 of the car seat 104 and the second strap is secured at the left ends 116 and 120 of the car seat 104. The middle of the two straps are then secured together over the car seat 104 via the pad component 108, much like the four straps are secured.

As shown in FIG. 2, the carrying strap device 100 comprises a body component 106 that is itself comprised of four rectangular straps with a front face 200 towards the car seat and a back face 202 away from the car seat. Further, the body component 106 comprises these four straps secured to a pre-existing infant car seat 104 at four different locations: the top right 114, bottom right 118, top left 116, and bottom left sides 120. All or substantially all of the straps are made of a polyester material 112 much like a seatbelt. The body component 106 preferably connects to the car seat 104 through a system of screws 204. There are four attachment points at the locations stated supra. Each attachment point is comprised of an anchor 206 which is connected to the molded edge 208 of the infant car seat 104. The anchor 206 is formatted in a loop so that a clasp 210 can hook onto said anchor 206. Finger screw down clasps 210 are attached to the end of each strap of the body component 106. These clasps 210 hook onto the anchors 206 on the car seat 104 so that the straps are secure. Each clasp 210 and anchor 206 system is made from steel 212 or any other material known in the art that allows for a stable and secure connecting system.

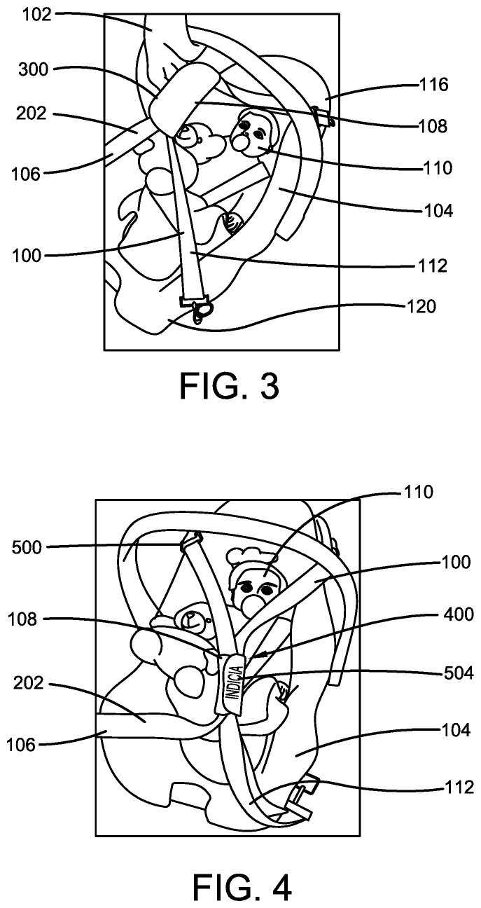

As shown in FIGS. 3-4, the body component 106 comprises a pad component 108 which connects all four straps of the body component 106. This pad component 108 is made of any kind of comfortable material known in the art. Once the four straps of the body component 106 are held in the center of the car seat 104. The pad component 108 wraps around all of them, thus keeping the four straps connected. The pad component 108 is then fastened to itself through hook and loop fasteners 300, or any other suitable securing means as is known in the art. The pad component 108 is fastened around the straps of the body component 106 keeping them all in place. The pad component 108 is arranged in a wide rectangular shape that can fold in on itself. The hook fasteners 300 are on one end of the rectangular face 400 and the loop fasteners 300 are on the same rectangular face 400, yet the opposite end. The pad component 108 allows for a wider surface area where a user 102 may hold the car seat 104 and ensures that the weight of all four straps within the body component 106 are evenly distributed so that less strength is necessary to lift the car seat 104. In one embodiment, the four straps are connected together first and then secured with the pad component 108. The straps of the body component 106 can be releasably secured together via any suitable securing means, such as snaps, hook and loop closures, buttons, etc.

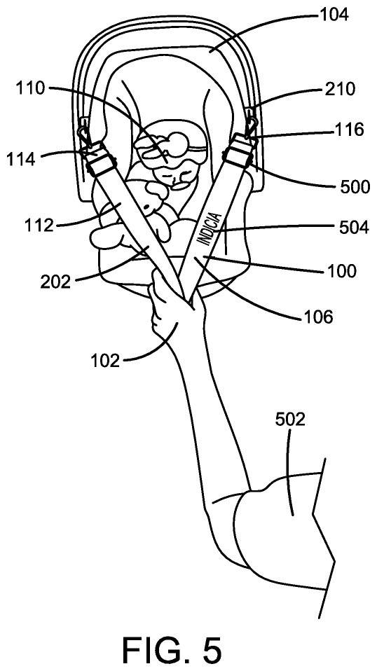

As shown in FIG. 5, the body component 106 also comprises strap adjusters 500 on each of the four straps. These strap adjusters 500 are placed near the car seat 104 and allow the straps of the body component 106 to be lengthened or shortened to the user's 102 preferred length. The strap adjusters 500 work much like one on any clothes, buckles, or straps of any kind. The strap adjuster 500 would also allow for the straps to be lengthened and thus, the pad component 108 can be placed over the user's shoulder 502 if preferred.

In one embodiment, the carrying strap device 100 comprises a plurality of indicia 504. The body component 106 of the device 100 may include advertising, a trademark, or other letters, designs, or characters, printed, painted, stamped, or integrated into the body component 106, or any other indicia 504 as is known in the art. Specifically, any suitable indicia 504 as is known in the art can be included, such as, but not limited to, patterns, logos, emblems, images, symbols, designs, letters, words, characters, animals, advertisements, brands, etc., that may or may not be child seat, infant, or brand related.

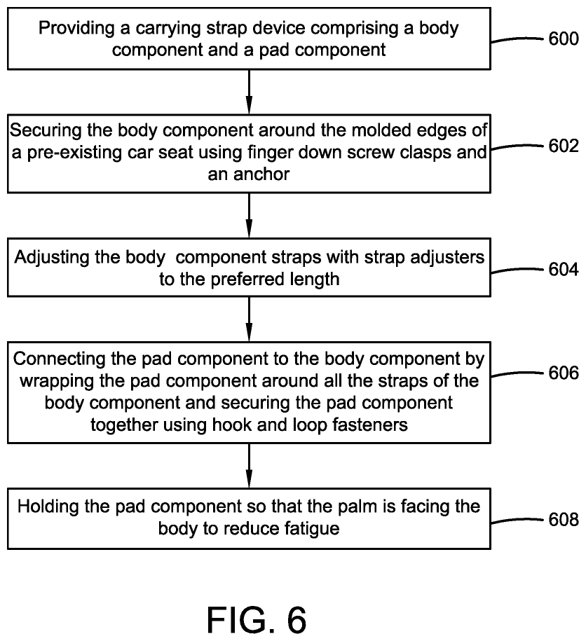

FIG. 6 illustrates a flowchart of the method of carrying an infant car seat with secondary straps. The method includes the steps of at 600, providing a carrying strap device comprising a body component and a pad component. The method also comprises at 602, securing the body component around the molded edges of a pre-existing car seat using finger screw down clamps and an anchor. Further, the method comprises at 604, adjusting the body component straps with strap adjusters to the preferred length. The method also comprises at 606, connecting the pad component to the body component by wrapping the pad component around all the straps of the body component and securing the pad component together using hook and loop fasteners. Finally, the method comprises at 608, holding the pad component so that the palm is facing the body to reduce fatigue.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “carrying strap device”, “carrying device”, “strap device”, and “device” are interchangeable and refer to the carrying strap device 100 of the present invention.

Notwithstanding the foregoing, the carrying strap device 100 of the present invention can be of any suitable size and configuration as is known in the art without affecting the overall concept of the invention, provided that it accomplishes the above stated objectives. One of ordinary skill in the art will appreciate that the carrying strap device 100 as shown in FIGS. 1-6 is for illustrative purposes only, and that many other sizes and shapes of the carrying strap device 100 are well within the scope of the present disclosure. Although the dimensions of the carrying strap device 100 are important design parameters for user convenience, the carrying strap device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A carrying strap device for use with an infant car seat, the carrying strap device comprising:
a body component;
a pad component; and
a securing means;
wherein the body component is comprised of four straps that are held together by the pad component; and
further wherein the body component is secured to an infant car seat via the securing means, to provide infant safety and user comfort.

2. The carrying strap device of claim 1, wherein the body component comprises four straps composed of a polyester material made in a rectangular shape.

3. The carrying strap device of claim 2, wherein the four straps each comprise a front face towards the inside of the infant car seat and a back face away from the infant car seat.

4. The carrying strap device of claim 3, wherein the body component is connected to the infant car seat with one strap on a top right, a bottom right, a top left, and a bottom left, respectively.

5. The carrying strap device of claim 4, wherein a securing means is finger down screw clamps which are connected to an end of each strap of the body component.

6. The carrying strap device of claim 5, wherein anchors are connected to the top right, the bottom right, the top left, and the bottom left of the infant car seat, so that they are fitted underneath molded edges of the infant car seat.

7. The carrying strap device of claim 6, wherein the finger down screw clamps of the body component hook onto the anchors on the infant car seat to ensure the body component remains on the infant car seat.

8. The carrying strap device of claim 7, wherein the pad component is folded around the four straps of the body component and secured to itself through securing means.

9. The carrying strap device of claim 8, wherein the securing means are hook and loop fasteners.

10. The carrying strap device of claim 9, wherein the body component comprises strap adjusters on each of the four straps, which allow for a length of the four straps to be adjusted.

11. The carrying strap device of claim 10, wherein the carrying strap device can be utilized by a user carrying the pad component in a user's hand or hung over a user's shoulder.

12. The carrying strap device of claim 11 further comprising a plurality of indicia.

13. A carrying strap device for use with an infant car seat, the carrying strap device comprising:
a body component comprising four rectangular straps with a front face and a back face;
a pad component; and
a plurality of hook and loop fasteners;
wherein each of the four rectangular straps comprise a finger screw down clasp on an end of each of the four rectangular straps;
wherein the pad component is looped around all four rectangular straps of the body component;
wherein a strap adjuster is positioned on each of the four rectangular straps to adjust strap length;
wherein anchors are placed around molded edges of the infant car seat; and
further wherein the pad component is held by a users hand or placed over a user's shoulder.

14. The carrying strap device of claim 13, wherein the four rectangular straps of the body component are placed on a top right, a bottom right, a top left, and a bottom left of the infant car seat.

15. The carrying strap device of claim 13, wherein the finger screw down clasps are secured to the anchors around the molded edges of the infant car seat.

16. The carrying strap device of claim 13, wherein the body component comprises only two rectangular straps, with one of the two rectangular straps being secured at the top right and the bottom right of the infant car seat and a second of the two rectangular straps being secured at the top left and bottom left of the infant car seat, with the two rectangular straps being connected in a middle via the pad component.

17. The carrying strap device of claim 13 further comprising a plurality of indicia.

18. The carrying strap device of claim 13, wherein the pad component connects the four rectangular straps of the body component in a middle of the infant car seat.

19. The carrying strap device of claim 18, wherein the pad component is made from thicker, more comfortable material and composed of a wide rectangular shape, so as to be easily handled.

20. A method of carrying an infant car seat with secondary straps, the method comprising the following steps:
providing a carrying strap device comprising a body component and a pad component;
securing the body component around the molded edges of the pre-existing infant car seat using finger screw down clamps and an anchor;
adjusting the body component straps with strap adjusters to the preferred length;
connecting the pad component to the body component by wrapping the pad component around all the straps of the body component and securing the pad component using hook and loop fasteners; and
holding the pad component so that the palm is facing the body to reduce fatigue.
